(19) United States
(12) Patent Application Publication
(10) Pub. No.: US 2024/0074932 A1
(43) Pub. Date: Mar. 7, 2024

(54) BUTTOCK SUPPORT FOR AT LEAST PARTIAL LOAD-RELIEF OF THE BODY WEIGHT OF A PERSON, AND LOAD-RELIEF SYSTEM COMPRISING SUCH A BUTTOCK SUPPORT

(71) Applicant: ReActive Robotics GmbH, München (DE)

(72) Inventors: Manfred KÖSTLMEIER, Haar (DE); Ramona Susanna SCHLÄFER, München (DE); Alexander KÖNIG, München (DE); Markus BIEDENKAPP, München (DE); Katharina Verena GUNDEL, München (DE); Maximilian GROSSE-DUNKER, Puchheim (DE); Michael ZIEGLER, Unterhaching (DE); Helfried PEYRL, Oberhaching (DE); Antonin Lucas DORÉ, München (DE)

(21) Appl. No.: 18/261,936

(22) PCT Filed: Jan. 19, 2022
(86) PCT No.: PCT/DE2022/100052

§ 371 Date: Jul. 18, 2023

(30) Foreign Application Priority Data
Jan. 21, 2021 (DE) 10 2021 101 293.7

(51) Int. Cl. A61G 13/12; A61G 7/057; A61G 7/065

(52) U.S. Cl. CPC A61G 13/123; A61G 7/05723; A61G 7/065

(57) ABSTRACT

Disclosed is a buttock support for at least partial load-relief of the body weight of a person, the buttock support having two support regions adapted to receive at least part of a buttock region of the person. Also disclosed is a load-relief system having the aforementioned buttock support. The two support regions are separated from one another by a gap and are rounded. The gap separates the two support regions from one another centrally. The buttock support significantly simplifies the connection of a person to the aforementioned load-relief system to prepare for manual and/or automated physical therapy and also ensures that the thigh region, in particular the inner face of the thigh, and the groin region are accessible for further medical/therapeutic treatment by the medical staff.

### FIELD OF THE INVENTION

The present invention relates to a buttock support for at least partial load-relief of the body weight of a person, at least comprising a receiving means for receiving at least part of a buttock region of the person, with a longitudinal extent, a height, a front face, a rear face, a top face and a bottom face, wherein the receiving means comprises at least one connecting element for operative connection to a bed or a load-relief system.

### BACKGROUND OF THE INVENTION

Both within the context of the rehabilitation of bedridden patients and during a targeted walking and/or running training session, it can be advantageous to regulate the weight loading on joints, bones, tendons and/or ligaments, etc. of a training person and/or to reduce it in comparison with loading by way of the entire body weight.

Different body weight load-relief systems have been disclosed for this purpose in the prior art.

DE 198 05 164 C1, DE 10 2014 004 997 A1, DE 10 2007 050 575 A1 and US 2017/024 60 69 A1 have disclosed, for example, training devices with an integrated body weight load-relief system, which training devices can be used for securing and weight load-relief of patients with walking difficulties, in particular stroke patients, when carrying out treadmill training.

A common feature of all the mentioned bodyweight load-relief systems is that the interaction between the respective apparatus and the user takes place via harnesses and/or belts which have to be arranged on the torso, on the hip and/or in the groin area of the user, in order to receive the latter in a secure and stable manner. In particular for the rehabilitation of the seriously ill and critically ill who cannot fasten harnesses/belts of this type themselves on account of unconsciousness, the known systems can make the care staff face the problem repeatedly of having to connect patients to the respective apparatus from a supine position, which makes lifting of the entire torso of the patient necessary. In addition, especially seriously ill patients are often connected to a multiplicity of diagnostic and/or therapeutic medical devices, such as ECGs, catheters and the like which cannot be taken off either during the rehabilitation measures, but should not be disrupted/impaired by way of the connection to a body weight load-relief system either.

In order to overcome this problem, the applicant has already proposed, in DE 10 2018 102 179 A1, a load-relief system for at least partial load-relief of the body weight of a person, which load-relief system makes a simple connection, in particular, of a bedridden patient to the load-relief system possible, as a result of which a comprehensive rearrangement of the patient and the disruption of other medical/therapeutic devices can be largely avoided and the patient is restricted in terms of his/her stepping/walking motion to a relatively small extent. However, the cuffs described therein for receiving at least part of an external extremity of a person impede access to the body via the thighs and/or the groin area (important positions for catheter ports which are used, in particular, in the case of veno-venous extracorporeal membrane oxygenation (VV-ECMO), in particular in the case of critically impaired patients requiring oxygenation.

Reference is additionally also to be made to DE 691 02 915 T2 within the context of the present invention.

### BRIEF SUMMARY OF THE INVENTION

Proceeding herefrom, the present invention is based on the object of further improving existing body weight load-relief systems of the prior art with regard to the connecting possibility to a user. The connection between a user, in particular a seriously ill, bedridden patient, and the load-relief system is intended here to be capable of being carried out as simply as possible and by a single person. Moreover, the body weight load-relief system is intended to be configured in such a way that a disruption or impairment of other medical devices which are connected to the body of the patient is avoided and, at the same time, a stepping/walking movement of the user is enabled without impediment.

This object is achieved first of all by way of a buttock support for at least partial load-relief of the body weight of a person with the features of independent patent claim 1 and by way of a load-relief system with the features of further independent claim 13.

In comparison with buttock supports which form the generic prior art, a buttock support according to the invention is distinguished by the fact that the receiving means comprises two support regions which are separated from one another by a gap, wherein the support regions are rounded at least with respect to the top face and the front face of the receiving means; and wherein the gap separates the two support regions from one another centrally with respect to the longitudinal extent of the receiving means.

The buttock support according to the invention makes it possible to connect a patient (for example, for preparation for manual and/or automated physical therapy) to a body weight load-relief system in a rapid and simple way. Here, the connection can advantageously be carried out by a single person, without it being necessary for the patient to be rotated with regard to his/her body longitudinal axis. Moreover, the gap according to the invention which separates the two support regions from one another centrally with regard to the longitudinal extent of the receiving means allows a medical treatment of the patient in the thigh and groin area, as is to take place, for example, via thigh catheter in the case of a patient who is oxygenated via veno-venous extracorporeal membrane oxygenation (VV-ECMO) to be advantageously maintained during the physical therapy. The rounded configuration of the two support regions at least with regard to the top face and the front face of the receiving means additionally leads, at every verticalization angle of a hospital bed which is assumed in order to carry out the physical therapy, for example by way of the verticalizable hospital bed, to an action of force on the ischial bones of the patient (at the buttock/support region contact point) which acts approximately perpendicularly with respect to a tangent with regard to the rounding of the respective support region, which has an advantageous effect on the “supporting/sitting feeling” of the patient and thus enables comfortable sitting on the buttock support. Finally, the buttock support according to the invention advantageously increases the freedom of movement of the thighs of the patient while said physical therapy is being carried out.

Further advantageous refinements and developments which can be used individually or in combination with one another are the subject matter of the respective dependent claims.

It has proven itself in one preferred refinement of the invention if the gap is between 2 and 7 cm, preferably between 4 and 5 cm, particularly preferably 4.75 cm. A gap in the range from 2 to 7 cm, preferably between 4 and 5 cm, particularly preferably 4.75 cm, advantageously allows the positioning of different catheters, sensors, etc. in the thigh and groin area of the patient.

In a further preferred refinement of the invention, the receiving means can be configured in one piece. A receiving means which is configured in one piece can advantageously be produced via additive manufacturing technologies.

As an alternative to this, one refinement of the buttock support according to the invention has also proven itself, in the case of which the receiving means is configured in multiple pieces, it being possible for the two support regions, in particular, to be configured as separate components. An alternative multiple-piece refinement advantageously enables a completely free selection with regard to the materials which are used for the individual components. Moreover, a multiple-piece refinement, in the case of which the support regions are preferably configured as separate components, makes it possible for the buttock support to be dismantled into individual parts for cleaning and disinfection. To this end, in particular, the support regions can be separated from the rest of the buttock support for cleaning after every use.

Furthermore, one refinement has proven itself, in the case of which the receiving means has a greater height in the region of its lateral faces than in the region of the gap. A greater height in the region of the lateral faces in comparison with the height in the region of the gap, that is to say widening at the outer edge of the buttock support, can advantageously reduce tilting of the buttock support. By virtue of the fact that it is not the entire buttock support, in particular the receiving means, but only the region close to the lateral faces which is widened, satisfactory handling when pushing the buttock support through below the legs of the person remains advantageously ensured, and the weight of the buttock support is also not increased unnecessarily. Moreover, a refinement of this type makes it simpler for the support regions and the base plane to terminate at the same height, which advantageously increases the comfort of use.

One refinement of the buttock support according to the invention is preferred according to the invention, in the case of which the two support regions are configured so as to project out of a base plane of the receiving means in the direction of its front face. A refinement of this type of the two support regions advantageously makes it possible to space the buttock area of the person away from the base plane of the receiving means and therefore also from the reclining surface of the hospital bed. This advantageously increases the accessibility of the thigh and groin area of the patient by way of medical staff.

Furthermore, one refinement of the buttock support according to the invention has proven itself, in the case of which the two support regions have a non-slip surface with respect to skin at least with regard to the top face and/or the front face. A non-slip surface of the support regions with respect to skin advantageously prevents the patient from slipping off the buttock support, in particular on the two support regions of the receiving means, during use. Here, slipping off can advantageously be prevented, in particular, during the verticalization of the hospital bed or during a change in the verticalization angle.

In addition, it is advantageous if the two support regions are formed from an elastic material or are provided with an elastic cushion layer at least with regard to the top face and/or the front face. The use of elastic material to configure the two support regions and/or the provision of said support regions with an elastic cushion layer advantageously increase/increases the seating comfort of the patient and prevent/prevents unnecessary pressure loads in the region of the buttock/support region contact point. A refinement of this type of the support regions at least with regard to the top face and/or the front face additionally also makes comfortable support during the entire radius of the movement carried out within the context of physical therapy possible.

It has proven itself in a further refinement if the buttock support comprises at least one, preferably two, belts for reversible fixing of the receiving means on the person. Belts of this type which are preferably arranged in the base plane of the receiving means and can be placed in each case around the thighs of the user and can then be connected in turn to the receiving means, in particular to its base plane, and/or run from a lateral face of the buttock support, in particular its receiving means, along the longitudinal extent of the buttock support to the other lateral face, advantageously make a further securing option possible for particularly greatly impaired (above all, also unconscious) patients against slipping off from the buttock support.

Moreover, one refinement of the invention has proven itself, in the case of which the receiving means, in particular the two support regions, are formed at least in sections from a disinfectable plastic, in particular from polyurethane, or are provided with a disinfectable coating, in particular made from polyurethane. The use of a disinfectable plastic as construction materials for the receiving means, in particular for the two support regions, and/or the provision of the receiving means, in particular of these regions, with a disinfectable coating, advantageously makes rapid and thorough cleaning or disinfection of those regions of the buttock support which come into contact with a patient possible. As a result, increased hygiene requirements, in particular in an intensive care unit, can also advantageously be met more simply.

It is also advantageous if the receiving means comprises at least one handle for transporting the buttock support, in particular the receiving means, when not in use. With the aid of a handle, the buttock support can be transported comfortably from one location of use to the next.

It has proven itself in a further refinement of the invention if the connecting element for operative connection to the bed comprises a connecting apparatus with at least one connecting arm, preferably two connecting arms, wherein the connecting arm or possibly the connecting arms is/are mounted pivotably via at least one joint, with the result that the buttock support can be moved from a storage position below a mattress of the bed into a use position above the mattress of the bed and vice versa. A connecting element which is configured in this way for operative connection to the bed advantageously makes it possible for the buttock support to be mounted on the bed in a manner which is space-saving and nevertheless always ready for use and, in order to use it, to be transferred into a use position in a rapid and uncomplicated manner. A buttock support which is configured in this way or a connecting element which is configured in this way for operative connection to the bed is suitable, in particular, for retrofitting to an already existing infrastructure in hospitals and care facilities.

Moreover, the present invention also relates to a load-relief system for at least partial load-relief of the body weight of a person, at least comprising a suspension means for fastening the load-relief system to a head end of a hospital bed, and a supporting means for operative connection of the suspension means to an apparatus for supporting the person, wherein the apparatus for supporting the person is a buttock support as described above.

In one preferred refinement of the load-relief system, it has proven itself here if the supporting means or a connecting means for operative connection to the load-relief system comprises a quick-action fastener which is configured to release the connection between the buttock support and the suspension means without further tools. A quick-action fastener of this type (“quick release fastener”) advantageously makes it possible to release the connection between the buttock support and the suspension means even when a certain tensile stress is still acting on the supporting means. This can be the case, in particular, when, after rehabilitation exercises have been carried out in a verticalized state of the bed, the latter is moved again into a horizontal position, and the completely relieved starting state is not set again between the mattress of the bed and the patient or the buttock support on account of friction.

The buttock support according to the invention and the load-relief system for at least partial load-relief of the body weight of a person comprising a buttock support of this type considerably facilitate the connection of a patient to said load-relief system in order to prepare for manual and/or automated physical therapy, since the patient no longer has to be rotated with regard to his/her body longitudinal axis during the installation, but rather the legs of the patient merely have to be angled and the buttock support has to be pushed in below the buttocks from one bedside. Here, the gap according to the invention for separating the two support regions advantageously maintains the accessibility of the thigh area, in particular the inner side of the thighs, and the groin area for continuing medical/therapeutic treatment by way of the medical staff. Finally, the buttock support according to the invention provides high supporting/sitting comfort for the patient during the entire range of movement of the therapy movement which is carried out.

### BRIEF DESCRIPTION OF THE SEVERAL VIEWS OF THE DRAWINGS

Additional details and further advantages of the invention will be described in the following text on the basis of preferred exemplary embodiments, to which the present invention is not restricted, however, and in conjunction with the appended drawing, in which, diagrammatically:

FIG. 1 shows one embodiment of a verticalizable hospital bed with a load-relief system for at least partial load-relief of the body weight of a person, and one embodiment of a buttock support according to the invention for said load-relief system,

FIG. 2 shows a side view of a first embodiment, configured in one piece, of a buttock support according to the invention,

FIG. 3 shows a frontal view of the embodiment of the buttock support from FIG. 2,

FIG. 4 shows a frontal view of a second embodiment, configured in multiple pieces, of a buttock support according to the invention,

FIG. 5 shows a frontal view of a third embodiment, configured in multiple pieces, of a buttock support according to the invention,

FIG. 6 shows a frontal view of a fourth embodiment, configured in multiple pieces, of a buttock support according to the invention,

FIG. 7 shows a side view of a fifth embodiment, configured in multiple pieces, of a buttock support according to the invention,

FIG. 8 shows a side view of a sixth embodiment, configured in multiple pieces, of a buttock support according to the invention,

FIG. 9 shows a seventh embodiment, configured in multiple pieces, of a buttock support according to the invention, in the case of which the support regions are oriented centrally with regard to a height of a base plane,

FIG. 10 shows a view of a top face of the embodiment from FIG. 9,

FIG. 11 shows an eighth embodiment, configured in multiple pieces, of a buttock support according to the invention, in the case of which the base plane of the receiving means is extended in the direction of the top face and comprises fastening elements for at least one belt,

FIG. 12 shows a ninth embodiment, configured in multiple pieces, of a buttock support according to the invention, in the case of which the base plane of the receiving means comprises a handle,

FIG. 13 shows a plan view by way of example of a bed with a buttock support arranged thereon which is operatively connected to a bed via two connecting elements which are configured as a rail/slide system for operative connection to said bed,

FIGS. 14 a-c show a sequence of figures of the operative connection of a further embodiment of a buttock support according to the invention to a bed via a corresponding connecting element comprising a connecting apparatus and pivotably mounted connecting arms; and

FIGS. 15 a-c show a sequence of figures of the operative connection of a further embodiment of a buttock support, configured in multiple pieces, according to the invention to a bed via a corresponding connecting element comprising a connecting apparatus and pivotably mounted connecting arms.

### DETAILED DESCRIPTION OF THE INVENTION

In the following description of preferred embodiments of the present invention, identical designations denote identical or comparable components.

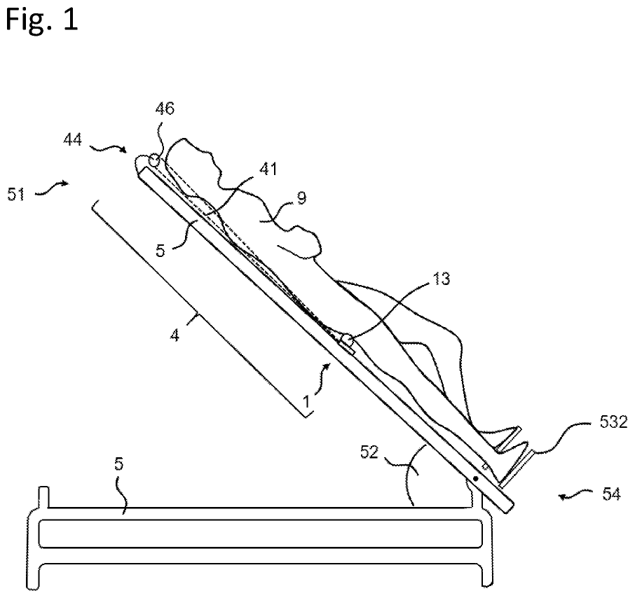

FIG. 1 shows one embodiment of a bed 5, in particular of a verticalizable hospital bed, with a load-relief system 4 for at least partial load-relief of the body weight of a person 9, and a refinement of a buttock support 1 according to the invention for said relief system 4.

For the preparation of manual and/or automated physical therapy of critically ill, in particular unconscious patients, said patients can preferably be connected in their verticalizable hospital bed 5 to a load-relief system 4 for at least partial load-relief of the body weight of the person 9. In this way, the performance of the rehabilitation movements can be carried out in a manner which is dependent on the verticalization angle set in each case by way of a verticalization mechanism 52 of a bed 5, in particular of a hospital bed, or of a standing table (not depicted), under the influence of an increasing correspondingly decreasing magnitude of the weight acting on the lower extremities of the person. Here, the load-relief system 4 makes both securing and support of the patient possible, by a part of the body weight being absorbed by the load-relief system 4, with the result that therapy movements can be carried out even at comparatively high verticalization angles (for example, >70°) which are necessary for the performance of a movement sequence which is as similar as possible to the normal walking movement, which therapy movements are adapted to the respective health state of the patient with regard to the weight loading on the lower extremities. Here, said therapy movement can be carried out manually by a physiotherapist or else can take place in an automated manner, preferably by way of a rehabilitation mechanism which is arranged at the foot end 54 of the hospital bed 5. To this end, FIG. 1 shows by way of example a foot module 532 of a rehabilitation mechanism of this type.

The load-relief system 4 according to the invention for at least partial load-relief of the body weight of a person 9 comprises at least one suspension means 44 for fastening the load-relief system 4 to a head end 51 of a bed 5, in particular of a hospital bed, and a supporting means 41 for operative connection of the suspension means 44 to a buttock support 1 according to the invention as apparatus for supporting the person 9.

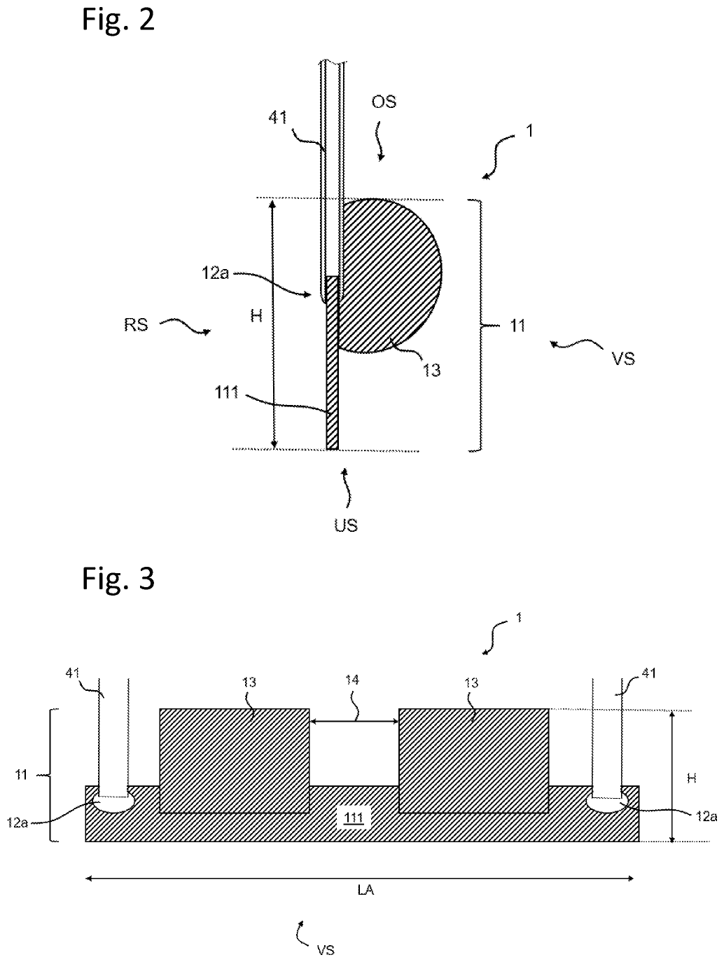

FIG. 2 and FIG. 3 show a side view (FIG. 2) and a frontal view (FIG. 3) of a first embodiment, configured in one piece, of a buttock support 1 according to the invention.

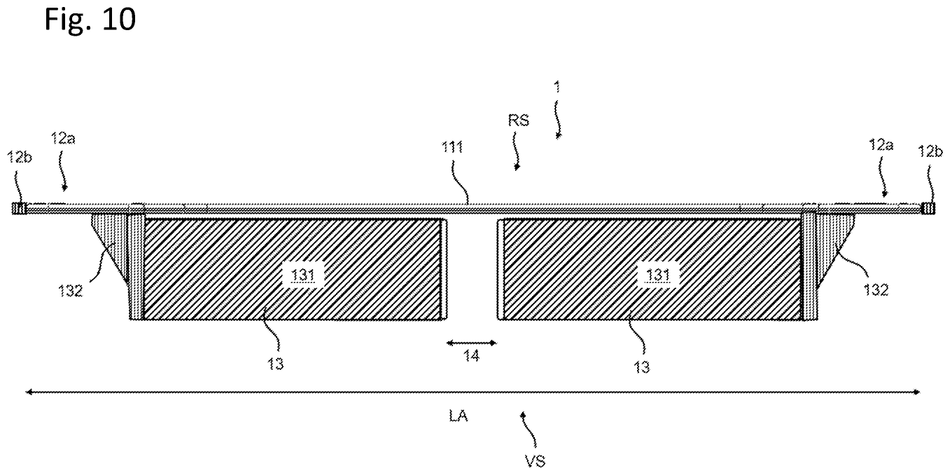

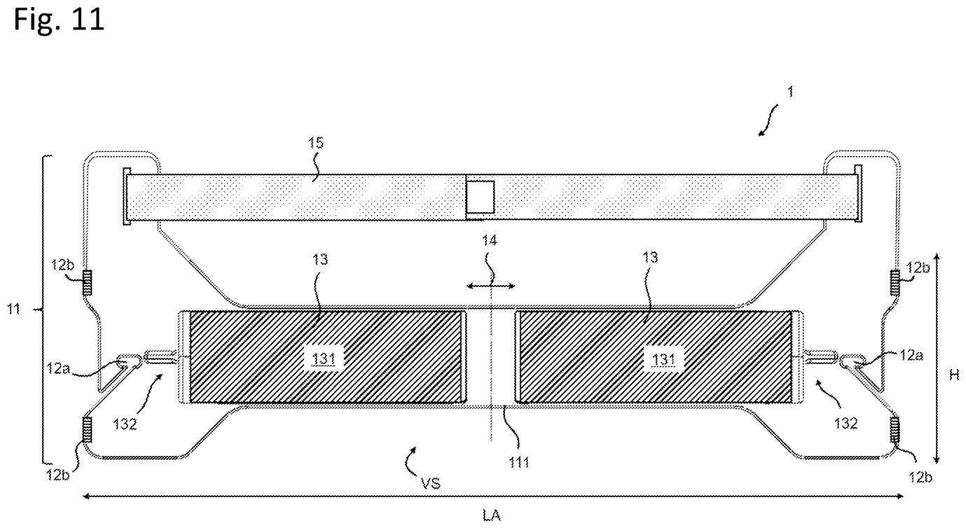

The buttock support 1 according to the invention for at least partial load-relief of the body weight of a person 9 comprises at least one receiving means 11 for receiving at least one part of a buttock region of the person 9, with a longitudinal extent LA, a height H, a front face VS, a rear face RS, a top face OS and a bottom face US. In addition, the receiving means 11 comprises at least one connecting element 12a; 12b for operative connection to the bed 5 (connecting element 12b, cf. FIGS. 9 and 10) or the load-relief system 4 (connecting element 12a). For operative connection to the load-relief system 4, two connecting elements 12a can preferably be arranged in the region of the lateral faces of the receiving means 11, in particular on its base plane 111. Here, the connecting means 12a for operative connection to the load-relief system 4 can preferably be arranged on the receiving means 11, in particular its base plane 111, centrally with regard to the height H of the receiving means 11 or shifted in the direction of the top face OS of the receiving means 11. An arrangement of the connecting means 12a shifted in the direction of the top face OS of the receiving means 11 advantageously counteracts a tilting moment of the buttock support 1. The connecting element 12a or, as shown here, the connecting elements 12a for operative connection to a load-relief system 4 can be configured here, in particular, as simple eyelets, through which supporting means 41 of the load-relief system 4 are guided. The connecting elements 12a can also, however, be configured as rollers or bearings (not shown here). As an alternative, the at least one connecting element 12a or in this case the two connecting elements 12a can finally also be configured as fixed attachments without degrees of freedom, for example in the form of a labyrinth connection, in the case of which the supporting means 41 can be threaded into a labyrinth arranged on the receiving means 11. A labyrinth connection of this type of the supporting means 41 and the buttock support 1 or its receiving means 11 advantageously makes the rapid exchange of the buttock support 1 possible for hygienic reasons or in the case of wear, but at the same time advantageously prevents unintentional release of the operative connection. Moreover, the receiving means 11 has two support regions 13 which are separated from one another by a gap 14. The gap 14 can be between 2 and 7 cm, preferably between 4 and 5 cm, particularly preferably 4.75 cm. The gap 14 separates the two support regions 13 from one another centrally with regard to the longitudinal extent LA of the receiving means 11, and advantageously enables not only improved accessibility of the thighs, the groin area and/or the intimate area of a person 9 seated on the buttock support 1 for further medical treatment, but rather also advantageously increases the use comfort of the buttock support 1, since, in particular, the intimate area of the person 9 is not subjected to any pressure forces. In addition, the support regions 13 are of rounded configuration at least with regard to the top face OS and the front face VS of the receiving means 11.

As shown in FIGS. 2 and 3, the receiving means 11 can be configured in one piece. Here, the two support regions 13 can preferably be configured so as to project from a base plane 111 of the receiving means 11 in the direction of its front face VS, in order to increase the spacing of the person 9 seated on the buttock support 1 from the receiving means 11, in particular its base plane 111, and therefore also from the bed surface of the hospital bed 5. In addition, the support regions 13 can also preferably protrude beyond the base plane 111 of the receiving means 11 in the direction of the top face OS of the receiving means 11. Both the spacing of the support elements 13 with regard to the front face VS and with regard to the top face OS of the receiving means 11 advantageously increase the accessibility of the thighs, the groin area and/or the intimate area of a person 9 seated on the buttock support 1 for a further medical treatment.

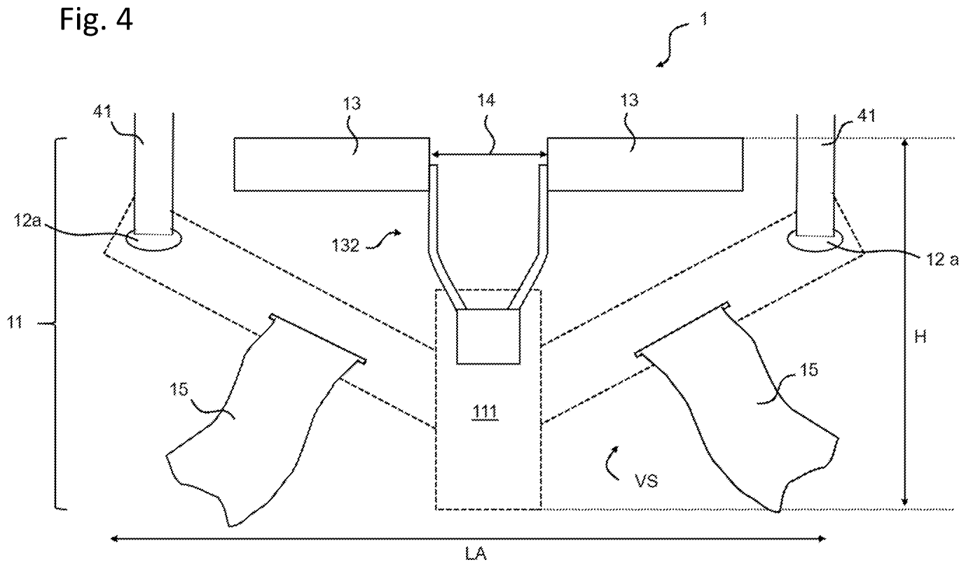

FIG. 4 shows a frontal view of a second embodiment, configured in multiple pieces, of a buttock support 1 according to the invention. The base plane 111 of the receiving means 11 and the two support regions 13 can be constructed as separate components, as shown here, and can preferably be connected to one another via a holder 132. In the embodiment which is shown here, the holder 132 is of approximately V-shaped configuration and is connected via a center element to two side elements of the receiving means 11 which together likewise point in a V-shaped manner in the direction of the top face OS of the receiving means 11. Connecting elements 12a for operative connection to the load-relief system 4, in particular via its supporting means 41, can in turn be arranged on the side elements.

As described in the first embodiment, the two support regions 13 can be configured so as to preferably project out of a base plane 111 of the receiving means 11 in the direction of its front face VS, in order to increase the spacing of the person 9 seated on the buttock support 1 from the receiving means 11, in particular its base plane 111, and therefore also from the bed surface of the hospital bed 5. In addition, the support regions 13 can also preferably protrude beyond the base plane 111 of the receiving means 11 in the direction of the top face OS of the receiving means 11. The “protruding beyond the base plate 111 of the receiving means 11 in the direction of the top face OS of the receiving means 11” is advantageously increased further by way of the approximately V-shaped arrangement of the side elements of the receiving means 11 in this embodiment.

Moreover, FIG. 4 also shows that the buttock support 1 can comprise at least one, preferably (as shown here) two, belts 15 for reversible fixing of the receiving means 11 on the person 9. A belt 15 of this type or belts 15 of this type can be provided both in the variant of single-piece configuration and in the variant of multiple-piece configuration of the receiving means 11. They serve as additional securing of the patient (the person 9) on the buttock support 1. The belt or belts 15 can advantageously be manufactured from an elastic material here and can be capable of being connected via slot-like openings reversibly to the buttock support 1, in particular its receiving means 11, with the result that the buttock support 1 can be converted simply and rapidly from a variant with belt 15/belts 15 into a variant without belt 15/belts 15. If the supporting means 41 is configured as a rigid element, the belt 15 or belts 15 can run, for example, starting centrally from the base plane 111 obliquely in the direction of the supporting means 41 (in the case of two supporting means 41 in the region of the lateral faces of the buttock support 1, in particular of its receiving means 11). The belt 15 or belts 15 can also run along the longitudinal extent LA of the buttock support 1 from one lateral face to the other. All course variants mentioned by way of example of the belt 15 or the belts 15 can advantageously serve as a further securing possibility against particularly greatly impaired, above all also unconscious, patients sliding off from the buttock support 1, and at the same time can ensure the freedom of movement of the legs of the person 9 here.

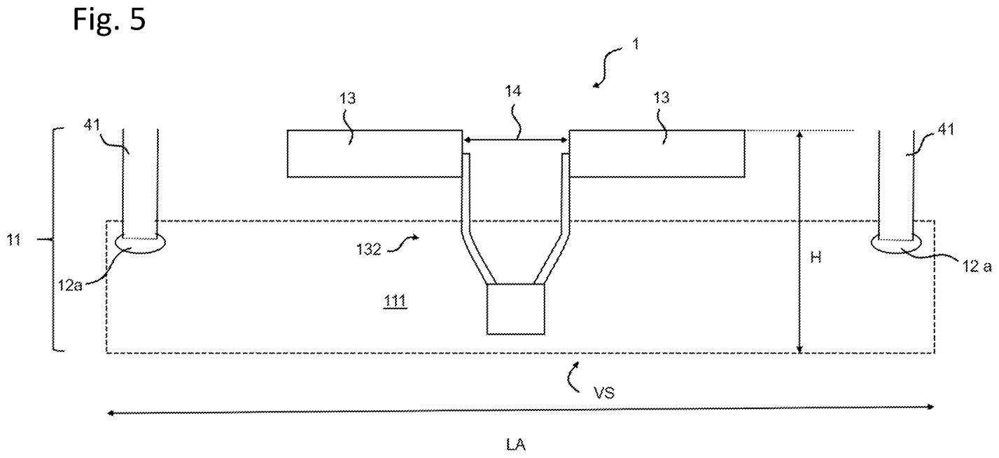

FIG. 5 shows a frontal view of a third embodiment, configured in multiple pieces, of a buttock support 1 according to the invention. In this embodiment of the buttock support 1 according to the invention, the base plane 111 of the receiving means 11 is configured as a rectangular component, on which the holder 132 for the support regions 13 is arranged. As in the previous example, the holder 132 can be of approximately V-shaped configuration and, likewise as before, can hold the two support regions 13 from the inside, that is to say in the region of the gap 14.

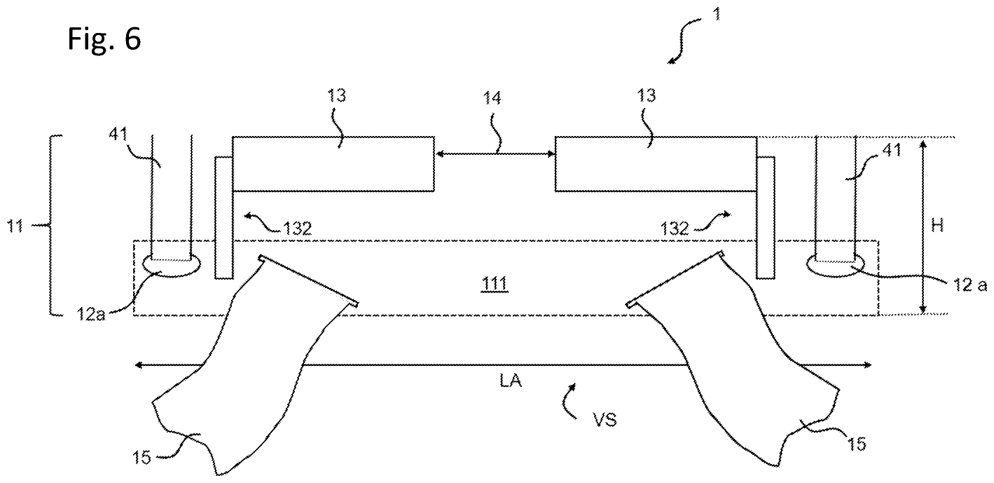

In contrast, FIG. 6 shows a frontal view of a fourth embodiment, configured in multiple pieces, of a buttock support 1 according to the invention, in which said holder 132 holds the support regions 13 in each case from the outside, that is to say on that side of the support regions 13 which in each case faces the lateral faces of the buttock support 1. As has already been mentioned above, all the embodiments which are shown can also comprise at least one, preferably two belts 15, for reversible fixing of the receiving means 11 on the person 9. In comparison with a fastening of the support regions 13 via holders 132 from the inside (as shown, for example, in the third embodiment (cf. FIG. 5)), in particular, an embodiment of this type advantageously has a reduction of components in the region of the gap 14 and therefore in the intimate region of the person 9 using the buttock support 1. In this variant, the holders 132 are advantageously far away from the intimate region during use, which decreases their contamination and increases the disinfectability.

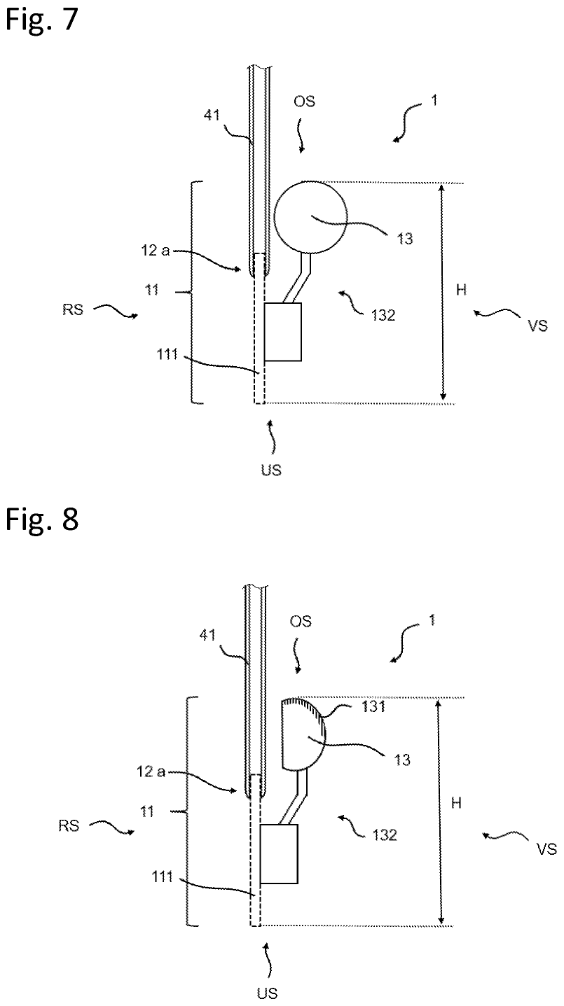

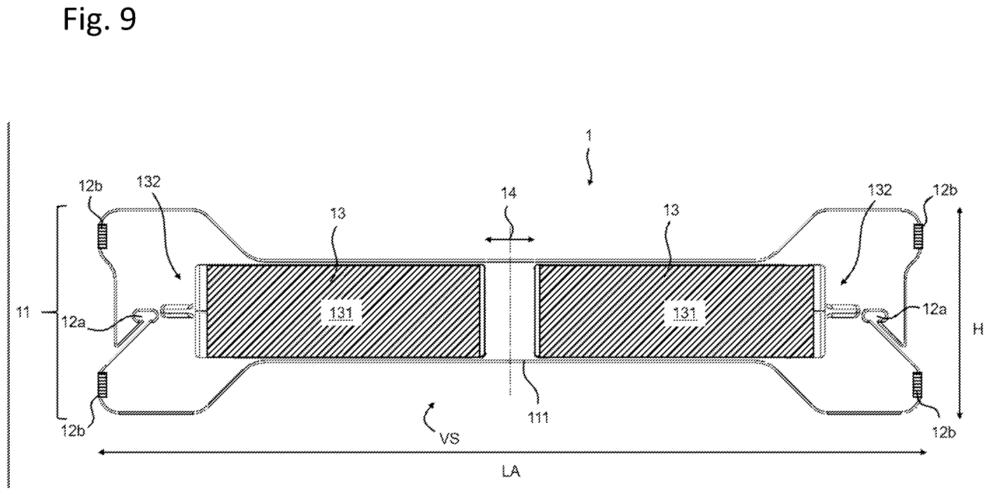

FIG. 7 and FIG. 8 in each case show a side view of two further embodiments of a buttock support 1 according to the invention. The figures serve for more detailed description of support regions 13 which are of different configuration. What is described in the following text in respect of the support regions 13 can be realized together with all the above-described embodiments of the receiving means 11.

According to the invention, the two support region 13 are of rounded configuration at least with regard to the top face OS and the front face VS of the receiving means 11. Here, as shown in FIG. 7, the support regions 13 can be of completely round configuration, that is to say in the form of cylinders with a circular cross section, or else, as shown in FIG. 8, can be configured as components which are only rounded with regard to the top face OS and the front face VS of the receiving means 11. In FIG. 8, an approximately semicircular cross section of the support regions 13 is selected for illustration purposes, but other cross-sectional shapes are also conceivable, as long as a rounded portion at least with regard to the top face OS and the front face VS of the receiving means 11 is ensured. The rounded configuration of the two support regions 13 at least with regard to the top face OS and the front face VS of the receiving means 11 advantageously leads, at every verticalization angle of a hospital bed 5 which is assumed, for example, by way of the verticalizable hospital bed 5 in order to carry out the physical therapy, to an action of force on the ischial bones of the patient (at the buttock/support region 13 contact point), which force acts approximately perpendicularly with respect to a tangent with regard to the rounding of the respective support region 13, which in turn has an advantageous effect on the “supporting/sitting feeling” of the patient and therefore makes comfortable sitting on the buttock support 1 possible.

The two support regions 13 can preferably be formed from an elastic material or can be provided with an elastic cushion layer 131 at least with regard to the top face OS and/or the front face VS. The use of an elastic material for the construction of the two support regions 13 advantageously increases the supporting/sitting comfort for the patient. If, as indicated in FIG. 8, an elastic cushion layer 131 is provided in the case of the construction of the support regions 13, the body of the respective support regions 13 can advantageously be constructed (independently of its elastic properties) from a different material, depending on the requirements for rigidity, weight, hygiene properties and/or processability of the material. In order to ensure satisfactory retention and prevention of a patient slipping off from the receiving means 11, in particular from its support regions 13, the two support regions 13 can additionally preferably have a non-slip surface with respect to skin at least with regard to the top face OS and/or the front face VS. A surface property of this type is advantageous, in particular, when the contact between the patient and the support region 13 takes place via the bare skin of the patient.

The receiving means 11, in particular the two support regions 13, can be formed at least in sections from a disinfectable plastic, in particular from polyurethane, or can be provided with a disinfectable coating, in particular made from polyurethane. This advantageously facilitates rapid and thorough cleaning, and makes multiple use possible with simultaneous maintenance of high hygiene standards.

FIGS. 9 and 10 show a seventh embodiment, configured in multiple pieces, of a buttock support 1 according to the invention, in the case of which the support regions 13 are oriented centrally with regard to a height H of a base plane 111.

In particular in the case of soft underlying surfaces such as, for example, a mattress, on which the buttock support 1 lies in the case of use, it can be advantageous if the support regions 13 and/or the holders 132 are arranged on the base plane 111 centrally with regard to the height H of the base plane 111, as shown here. In this way, torques which act on the buttock support 1 and are caused by way of the weight of the patient can advantageously be compensated for, which in turn reduces raised edges and associated punctiform loading of the mattress. FIG. 9 shows two connecting means 12a, arranged centrally with regard to the height H of the receiving means 11, for operative connection to the load-relief system 4. As has already been explained above in the description of the figures in respect of FIGS. 2 and 3, the connecting means 12a for operative connection to the load-relief system 4 can also preferably be arranged on the receiving means 11, in particular on its base plane 111, shifted in the direction of the top face OS of the receiving means 11 with regard to the height H of the receiving means 11, however, and can advantageously counteract a tilting moment of the buttock support 1 as a result.

It can also be seen in FIG. 9 that the receiving means 11 can have a greater height H in the region of its lateral faces than in the region of the gap 14. A greater height H in the region of the lateral faces in comparison with the height H in the region of the gap 14, that is to say a widening at the outer edge of the buttock support 1, can advantageously reduce tilting of the buttock support 1. Here, said widening at the outer edge does not have to be symmetrical (as shown in FIG. 9) with regard to a center axis (=longitudinal axis LA at a middle height H) of the receiving means 11. Instead, the outer edges of the buttock support 1 can also extend further away from the center axis of the receiving means 11 in the direction of the bottom face US of the receiving means 11 than in the direction of the top face OS of the receiving means 11. An embodiment of this type which is asymmetrical with regard to the center axis can advantageously further counteract a tilting moment. By virtue of the fact that it is not the entire buttock support 1, in particular the receiving means 11, but rather only the region close to the lateral faces which is widened, satisfactory handling advantageously remains ensured when pushing the buttock support 1 through below the legs of the person 9, and the weight of the buttock support 1 is also not increased unnecessarily either. The support regions 13 and the base plane 111 preferably terminate at the same height with regard to the height of their upper edge, as shown here, which advantageously increases the use comfort, since no protruding edge is formed in this way. As an alternative to this, the upper edge of the base plane 111 can also lie below the upper edges of the support regions 13 in this embodiment, which results in a situation as, for example, in the embodiments which are shown in FIGS. 3 to 6, that is to say the buttocks of the person 9 are spaced apart from the upper edge of the base plane 111 during use of the buttock support 1 and, as a result, possibly unpleasant contact outside the support regions 13 between the tissue of the person 9 and the receiving means 11, in particular its base plane 111, is advantageously avoided. To this end, the upper edge of the base plane 111, in particular in the region above the support regions 13 and the gap 14, can preferably end 1 cm below the upper edges of the support regions 13.

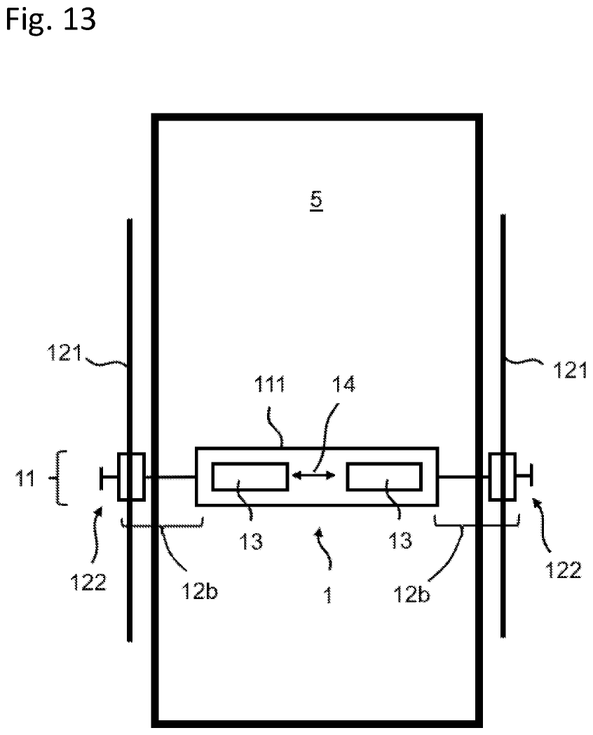

In this embodiment, the receiving means 11 also comprises two connecting elements 12b for operative connection to the bed 5. One or more connecting means 12b of this type can be arranged on the receiving means 11 as an alternative or in addition to one or more of the connecting means 12a for operative connection to a load-relief system 4. Here, a connecting means 12b of this type for operative connection to the bed 5 is preferably configured in such a way that it makes an operative connection, which is rigid but can be displaced along the longitudinal faces of the bed 5, between the receiving means 11 and the bed 5 possible. This can be realized, in particular, by way of a connecting means 12b of slide-like configuration which engages into a rail 121 arranged on the bed 5 and can be shifted therein along the longitudinal faces of the bed 5 and can be fixed reversibly at a position with regard to the longitudinal faces of the bed 5. One example for an embodiment of this type of the connecting means 12b is shown in FIG. 13. Here, the part, configured as a slide, of the connecting element 12b, configured as a rail/slide system, for operative connection to a bed 5 can be fixed temporarily for use in the desired position with regard to the longitudinal face of the bed 5 on the rail 121 which runs along the longitudinal faces of the bed 5 via a fastening system 122, in particular a screw-type fastener system. A connecting element 12b for operative connection to the bed 5 has the advantage that the buttock support 1 for at least partial load-relief of the body weight of a person 9 can be secured on the bed 5, and no supporting means 41 for operative connection of the suspension means 44 is required for fastening a load-relief system 4 to a head end 51 of a bed 5 with the buttock support 1. A possible collision of the supporting means 41 with the person 9 can advantageously be avoided as a result.

FIG. 11 shows an eighth embodiment, configured in multiple pieces, of a buttock support 1 according to the invention, in the case of which the base plane 111 of the receiving means 11 is extended in the direction of the top face OS and comprises fastening elements for at least one belt 15. An extension of this type of the base plane 111 in the direction of the top face OS can of course also be provided in the case of buttock supports 1 of single-piece configuration, as shown in FIGS. 2 and 3. An extension of the base plane 111 of the receiving means 11 in the direction of the top face, that is to say in the case of use in the direction of the head end of the bed 5, advantageously makes it possible, as shown, for fastening elements to be provided for at least one belt 15 which can then serve, as an alternative to or in accumulative manner with respect to the belts 15 shown in FIGS. 4 and 6, for reversible fixing of the receiving means 11 on the person 9.

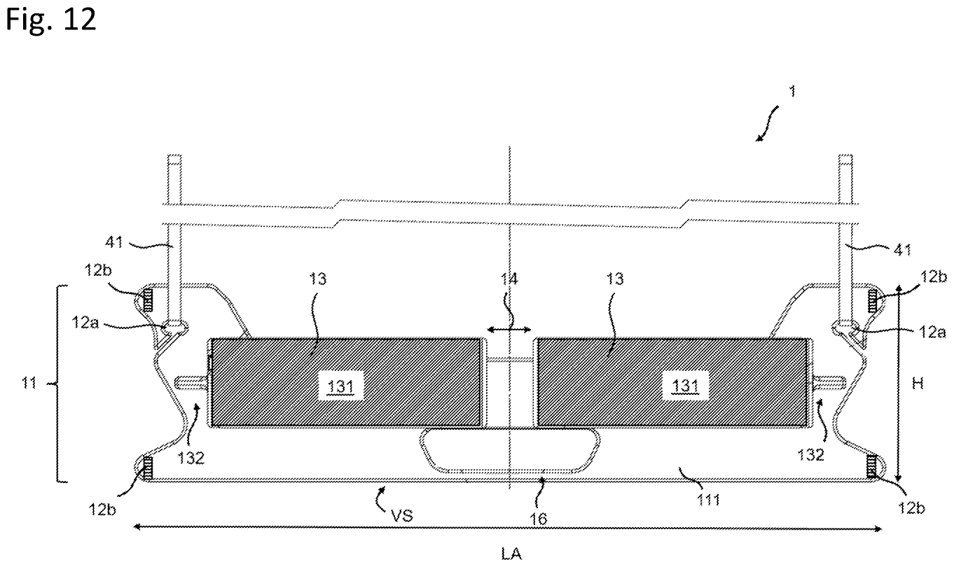

FIG. 12 shows a ninth embodiment, configured in multiple pieces, of a buttock support according to the invention, in the case of which the base plane 111 of the receiving means 11 comprises a handle 16. A handle 16 of this type which, in particular as shown here, can be configured as a gap in the base plane 111 of the receiving means 11 advantageously makes the simple transport of the buttock support 1 according to the invention possible. All embodiments of the buttock support 1 according to the invention can comprise a handle 16 of this type, it being possible for the respective handle 16 to be configured as a gap, as shown here, or as a component which protrudes out of the base plane 111 of the receiving means 11. As can additionally be seen in FIG. 12, the at least one connecting means 12a or the two connecting means 12a can be arranged on the receiving means 11, in particular its base plane 111, displaced in the direction of the top face OS of the receiving means 11. An eccentric arrangement of this type of the connecting means 12a with regard to the height H of the receiving means 11 can advantageously counteract tilting or “tipping up” of the buttock support 1 and, as has already been described with respect to FIGS. 2 and 3, can be realized in the case of all embodiments of the buttock support 1 according to the invention.

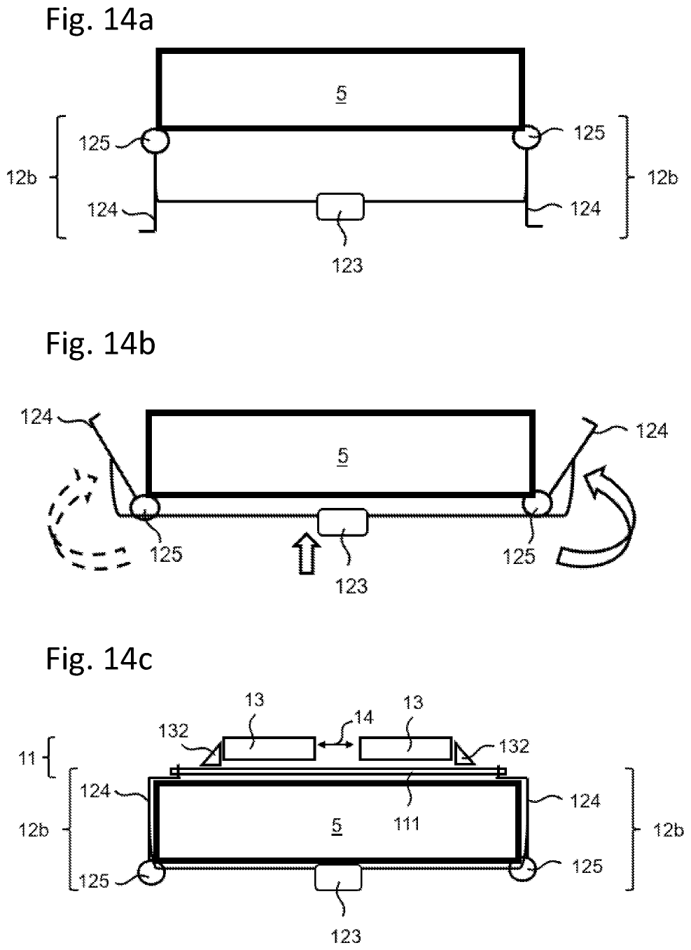

FIGS. 14 a-c and 15a-c in each case show a sequence of figures of the operative connection of further embodiments of a buttock support 1 according to the invention to a bed 5 via a corresponding connecting element 12b for operative connection of the buttock support 1 to a bed 5, comprising a connecting apparatus 123 and pivotably mounted connecting arms 124.

A connecting element 12b which connects, via a connecting apparatus 123, two connecting arms 124 which are mounted pivotably with respect to the bed 5 via joints 125 is provided in the embodiment in FIGS. 14a to 14c for operative connection of a buttock support 1 according to the invention to a bed 5. FIG. 14a shows the situation in the case of non-use: the connecting element 12b or the connecting arms 124 is/are pivoted into a region below the bed 5. The receiving means 11 can be removed in this storage position and can be stored separately, but it can also remain connected to one of the two connecting arms 124 (not shown here). For use of the buttock support 1, the user, in particular a person belonging to the medical staff, can activate at least one of the connecting arms 124, for example by way of pivoting it up, as a result of which, via the connecting apparatus 123, the second connecting arm 124 can also be activated or pivoted upward (cf. FIG. 14b). For use of the buttock support 1 in its use position above the mattress of the bed 5, the receiving means 11 can then advantageously either be pivoted below the legs of the person 9 from the connecting arm 124 on one side to the connecting 124 on the other side, or else, if the receiving means 11 has been stored separately, can be guided through below the legs of the person 9 and can then be fastened to the two connecting arms 124 (FIG. 14c).

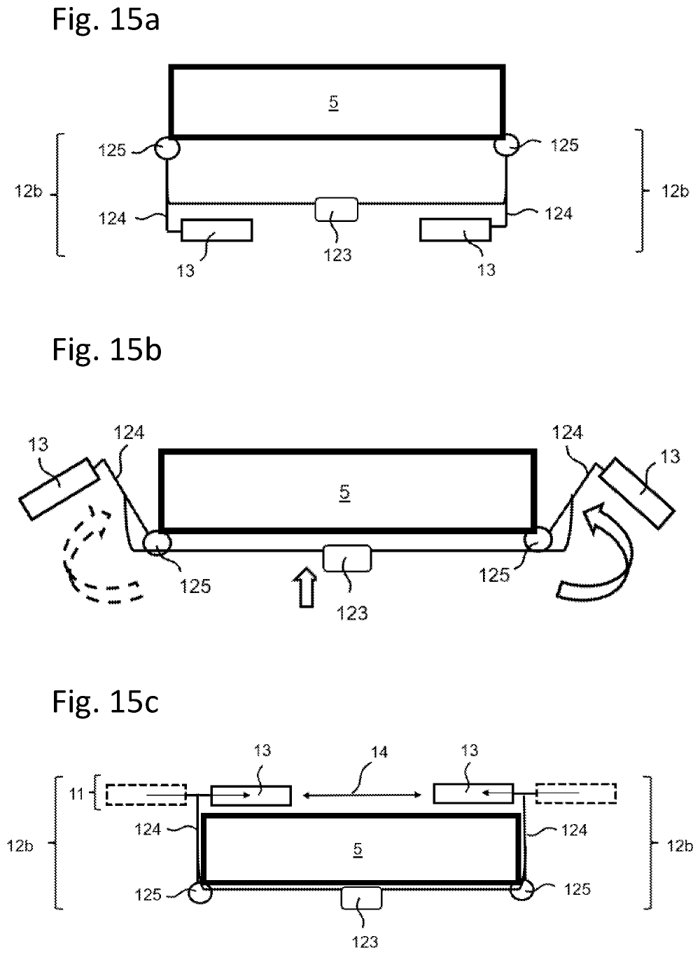

In the case of the embodiment which is shown in FIGS. 15a to 15c, the receiving means 11 is configured in multiple pieces in such a way that the two support regions 13 are arranged on different connecting arms 124 of the connecting element 12b in the storage position of the buttock support 1. The transfer from the storage position to the use position can take place as in the embodiment which is shown in FIGS. 14a-c, it being possible for the two support regions 13 to advantageously be arranged displaceably on the connecting arms 124, with the result that the gap 14 between the two support regions 13 can be decreased or increased in the use position (FIG. 15c).

The present invention relates to a buttock support 1 for at least partial load-relief of the body weight of a person 9, at least comprising a receiving means 11 for receiving at least part of a buttock region of the person 9, and to a load-relief system 4 comprising the aforementioned buttock support 1. The buttock support 1 is characterized in that the receiving means 11 comprises two support regions 13 which are separated from one another by a gap 14, wherein the support regions 13 are rounded at least with respect to the top face OS and the front face VS of the receiving means 11; and wherein the gap 14 separates the two support regions 13 from one another centrally with respect to the longitudinal extent LA of the receiving means 11. The invention significantly simplifies the connection of a person 9 to the aforementioned load-relief system 4 to prepare for manual and/or automated physical therapy and also ensures that the thigh region, in particular the inner face of the thigh, and the groin region are accessible for further medical/therapeutic treatment by the medical staff.

### LIST OF DESIGNATIONS

1 Buttock support
11 Receiving means
111 Base plane
12a Connecting element for operative connection to the load-relief system (4)
12b Connecting element for operative connection to the bed (5)
121 Rail
122 Fastener system
123 Connecting apparatus
124 Connecting arm
125 Joint
13 Support region
131 Cushion layer
132 Holder
14 Gap
15 Belt
16 Handle
4 Load-relief system for at least partial body weight load-relief
41 Supporting means
44 Suspension means
46 Guide means
5 Bed, in particular verticalizable hospital bed
51 Head end
52 Verticalization mechanism
532 Foot module
54 Foot end
9 Person
LA Longitudinal extent
H Height
VS Front face
RS Rear face
OS Top face
US Bottom face

1. A buttock support for at least partial load-relief of the body weight of a person, the buttock support comprising:
a receiving means for receiving at least part of a buttock region of the person, the receiving means having a longitudinal extent, a height, a front face, a rear face, a top face and a bottom face;
wherein the receiving means comprises at least one connecting element for operative connection to a bed or a load-relief system;
wherein the receiving means further comprises two support regions which are separated from one another by a gap, wherein the support regions are rounded at least with respect to the top face and the front face the receiving means; and wherein the gap separates the two support regions from one another centrally with respect to the longitudinal extent of the receiving means.

2. The buttock support of claim 1, wherein the gap is between 2 and 7 cm.

3. The buttock support of claim 1, wherein the receiving means is configured in one piece.

4. The buttock support of claim 1, wherein the receiving means is configured in multiple pieces, the two support regions, in particular, being configured as separate components.

5. The buttock support of claim 1, wherein the receiving means has a greater height in the region of its lateral faces than in the region of the gap.

6. The buttock support of claim 1, wherein the two support regions are configured so as to project out of a base plane of the receiving means in the direction of its front face.

7. The buttock support of claim 1, wherein the two support regions have a non-slip surface with respect to skin at least with regard to the top face and/or the front face.

8. The buttock support of claim 1, wherein the two support regions are formed from an elastic material or are provided with an elastic cushion layer at least with regard to the top face and/or the front face.

9. The buttock support of claim 1, further comprising at least one belt for reversible fixing of the receiving means on the person.

10. The buttock support of claim 1, wherein the receiving means, in particular the two support regions, are formed at least in sections from a disinfectable plastic made from polyurethane, or are provided with a disinfectable coating made from polyurethane.

11. The buttock support of claim 1, wherein the receiving means comprises at least one handle for transporting the buttock support, in particular the receiving means, when not in use.

12. The buttock of claim 1, wherein the connecting element for operative connection to the bed comprises a connecting apparatus with at least one connecting arm wherein the at least one connecting arm is mounted pivotably via at least one joint, with the result that the buttock support can be moved from a storage position below a mattress of the bed into a use position above the mattress of the bed and vice versa.

13. A load-relief system for at least partial load-relief of the body weight of a person, the load-relief system comprising:
a suspension means for fastening the load-relief system to a head end of a bed, in particular of a hospital bed; and
a supporting means for operative connection of the suspension means to an apparatus for supporting the person;
wherein the apparatus for supporting the person is a buttock support as claimed in claim 1.

14. The load-relief system of claim 13, wherein the supporting means or a connecting element for operative connection to the load-relief system comprises a quick-action fastener which is configured to release the connection between the buttock support and the suspension means without further tools.

15. The buttock support of claim 2, wherein the gap is between 4 and 5 cm.

16. The buttock support of claim 15, wherein the gap is 4.75 cm.
